(19) United States
(12) Patent Application Publication
(10) Pub. No.: US 2013/0336175 A1
(43) Pub. Date: Dec. 19, 2013

(54) METHOD AND APPARATUS FOR DUPLEX IN COGNITIVE RADIO COMMUNICATION SYSTEM

(71) Applicant: Electronics and Telecommunications Research Institute, Daejeon (KR)

(72) Inventors: Jung Sun UM, Daejeon (KR); Byung Jang JEONG, Daejeon (KR); Sang Won KIM, Daejeon (KR); Sung Jin YOO, Daejeon (KR); Jae Ick CHOI, Daejeon (KR)

(21) Appl. No.: 13/912,854

(22) Filed: Jun. 7, 2013

(30) Foreign Application Priority Data
Jun. 14, 2012 (KR) 10-2012-0063962
Feb. 18, 2013 (KR) 10-2013-0016689

(51) Int. Cl. H04L 5/14

(52) U.S. Cl. CPC H04L 5/14
USPC 370/280; 370/277; 370/281

(57) ABSTRACT

Provided is a method for duplex in a cognitive radio communication system, including: collecting radio environment information including information of usable radio resources; determining a duplex scheme for each radio resource based on the radio environment information; and allocating at least one of the radio resources to information to be transmitted and received, depending on characteristics of the information.

### CROSS-REFERENCE TO RELATED APPLICATIONS

This application claims priority to and the benefit of Korean Patent Application No. 10-2012-0063962 filed on Jun. 14, 2012 and 10-2013-0016689 filed on Feb. 18, 2013 in the Korean Intellectual Property Office, the entire contents of which are incorporated herein by reference.

### TECHNICAL FIELD

The present invention relates to a cognitive radio technology, and more particularly, to a method and an apparatus for operating FDD and TDD together in a duplex mode in a cognitive radio communication system.

### BACKGROUND ART

A usable frequency band substantially reaches a saturation state due to various types of radio communication technologies that have been developed rapidly and a cognitive radio (CR) technology that is one of the methods for solving a lack of a radio resource has been used. The cognitive radio technology is a technology that cognizes the radio environment that is dynamically changed due to intelligence of terminal devices and a network and detects a white space (WS) not used by the existing users so as to optimally utilize an idle radio resource.

In the cognitive radio system, while a frequency band (licensed band) of a primary user, that is, a licensed user is not used by the licensed user, a secondary user uses the frequency band. Meanwhile, there are an unlicensed band and a so-called quasi-licensed band having an attribute approximating an unlicensed band as bands other than the licensed band. The unlicensed band and the quasi-licensed band are referred to as a shared band as a band that may be freely used under a condition that the secondary users do not interfere with each other The shared band may include industrial, scientific and medical (ISM), unlicensed national information infrastructure (UNII), TV white space (TVWS), authorized shared access (ASA), and the like.

Meanwhile, frequency spectra of specific countries are generally allocated by radio frequency management agencies of governments in each country. As the method for allocating spectra, there are a paired spectrum and an unpaired spectrum. FIG. 1 illustrates a concept of the paired spectrum and the unpaired spectrum.

As illustrated in FIG. 1, the paired spectrum that is given as a pair of frequency bands is generally used for communication in a frequency division multiplex (FDD) scheme. That is, one of the two frequency bands is used as an uplink and the other is used as a downlink. A frequency band of a mobile communication system operated by the FDD scheme as a licensed band is allocated as the paired spectrum.

On the other hand, as illustrated in FIG. 1, the unpaired spectrum that is given as one frequency band is generally used for communication in a time division multiplex (TDD) scheme. A frequency band of a mobile communication system operated by the TDD scheme as a licensed band is allocated as the unpaired spectrum. Most of the shared bands, such as the foregoing unlicensed band or the quasi-licensed band, are also allocated as the unpaired spectrum. The shared band to be generated later will be also allocated as the unpaired spectrum.

In the cognitive radio communication system, since the secondary users use both of the licensed band and the shared band as needed or depending on the situations, in order to effectively use the frequency band in the situation in which the paired spectrum and the unpaired spectrum are mixed, a duplex method using the FDD scheme and the TDD scheme together is required.

### SUMMARY OF THE INVENTION

The present invention has been made in an effort to provide a method and an apparatus for duplex in a cognitive radio communication system capable of effectively using both an FDD scheme and a TDD scheme in the radio environment in which a licensed band, a shared band, a paired spectrum, and an unpaired spectrum are mixed

An exemplary embodiment of the present invention provides a method for duplex in a cognitive radio communication system, including: collecting radio environment information including information of usable radio resources; determining a duplex scheme for each radio resource based on the radio environment information; and allocating at least one of the radio resources to information to be transmitted and received, depending on characteristics of the information.

In the determining, the duplex scheme for the radio resource may be determined depending on whether the radio resource belongs to a licensed band or a shared band.

In the determining, the duplex scheme for the radio resource may be determined depending on whether the radio resource corresponds to a paired spectrum or an unpaired spectrum.

In the determining, when the radio resource corresponds to a paired spectrum as a licensed band, the duplex scheme for the radio resource may be determined to be FDD.

In the determining, when the radio resource corresponds to an unpaired spectrum as a licensed band or an unpaired spectrum as a shared band, the duplex scheme for the radio resource may be determined to be TDD.

In the allocating, at least one of the radio resources may be allocated depending on importance, type, or service characteristics of the information.

In the allocating, a radio resource for which the duplex scheme is determined to be FDD and a radio resource for which the duplex scheme is determined to be TDD may be optionally allocated depending on whether a required quality of service (QoS), delay sensitivity, or channel reciprocity is used.

In the allocating, a radio resource for which the duplex scheme is determined to be FDD and a radio resource for which the duplex scheme is determined to be TDD may be optionally allocated depending on symmetry of a service traffic ratio of an uplink and a downlink.

In the allocating, when the information is broadcasting information, control information, or resource allocation information of a system/network to be transmitted to a user terminal, the radio resource belonging to a licensed band may be preferentially allocated.

Another exemplary embodiment of the present invention provides an apparatus for duplex in a cognitive radio communication system, including: a radio environment information collection unit that collects radio environment information including information of usable radio resources; a radio resource management unit that determines a duplex scheme for each radio resource based on the radio environment information; and a radio resource allocation unit that allocates at least one of the radio resources to information to be transmitted and received, depending on characteristics of the information.

The radio resource management unit may determine the duplex scheme for the radio resource depending on whether the radio resource belongs to a licensed band or a shared band.

The radio resource management unit may determine the duplex scheme for the radio resource depending on whether the radio resource corresponds to a paired spectrum or an unpaired spectrum.

The radio resource management unit may determine the duplex scheme for the radio resource as FDD when the radio resource corresponds to a paired spectrum as a licensed band.

The radio resource management unit may determine the duplex scheme for the radio resource as TDD when the radio resource corresponds to an unpaired spectrum as a licensed band or an unpaired spectrum as a shared band.

The radio resource allocation unit may allocate at least one of the radio resources depending on importance, type, or service characteristics of the information.

The radio resource allocation unit may optionally allocate a radio resource for which the duplex scheme is determined to be FDD and a radio resource for which the duplex scheme is determined to be TDD, depending on whether a required quality of service (QoS), delay sensitivity, or channel reciprocity is used.

The radio resource allocation unit may optionally allocate a radio resource for which the duplex scheme is determined to be FDD and a radio resource for which the duplex scheme is determined to be TDD, depending on symmetry of a service traffic ratio of an uplink and a downlink.

The radio resource allocation unit may preferentially allocate the radio resource belonging to a licensed band when the information is broadcasting information, control information, or resource allocation information of a system/network to be transmitted to a user terminal.

According to the exemplary embodiments of the present invention, in the cognitive radio communication system, it is possible to effectively use the FDD scheme and the TDD scheme in the radio environment in which the licensed band, the shared band, the paired spectrum, and the unpaired spectrum are mixed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a concept of a paired spectrum and an unpaired spectrum.

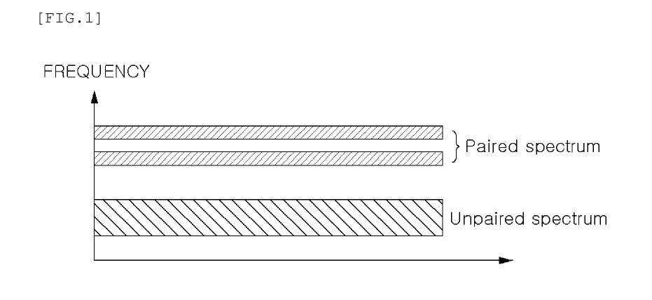

FIGS. 2A, 2B, and 2C comparatively illustrate concepts of FDD, TDD, and HDD, respectively.

FIG. 3 is a block diagram of a duplex apparatus in accordance with an exemplary embodiment of the present invention.

FIG. 4 is a flow chart of a method for duplex in a cognitive radio communication system according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Like reference numerals designate like components having substantially the same constitution and function in the drawings of the present invention and an overlapping description thereof will be omitted. When it is determined that the detailed description of the known art related to the present invention may unnecessarily obscure the gist of the present invention, the detailed description thereof will be omitted.

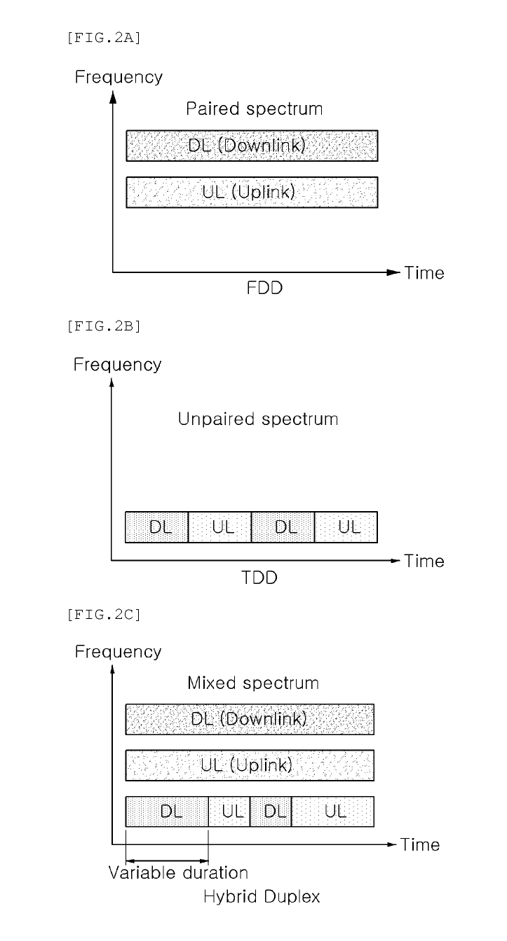

In order to effectively use both an FDD scheme and a TDD scheme in the radio environment in which a licensed band, a shared band, a paired spectrum, and an unpaired spectrum are mixed, the FDD and the TDD need to be supported simultaneously. A scheme that simultaneously supports the FDD and the TDD may be called a hybrid division duplex (HDD) scheme. FIGS. 2A, 2B, and 2C comparatively illustrate concepts of FDD, TDD, and HDD, respectively. Referring to FIG. 2C, the paired spectrum and the unpaired spectrum coexist (mixed spectrum) in the HDD scheme and duration of an uplink or a downlink in the TDD may vary.

Hereinafter, exemplary embodiments of an apparatus and a method for duplex capable of supporting FDD and TDD simultaneously in the cognitive radio communication system will be described.

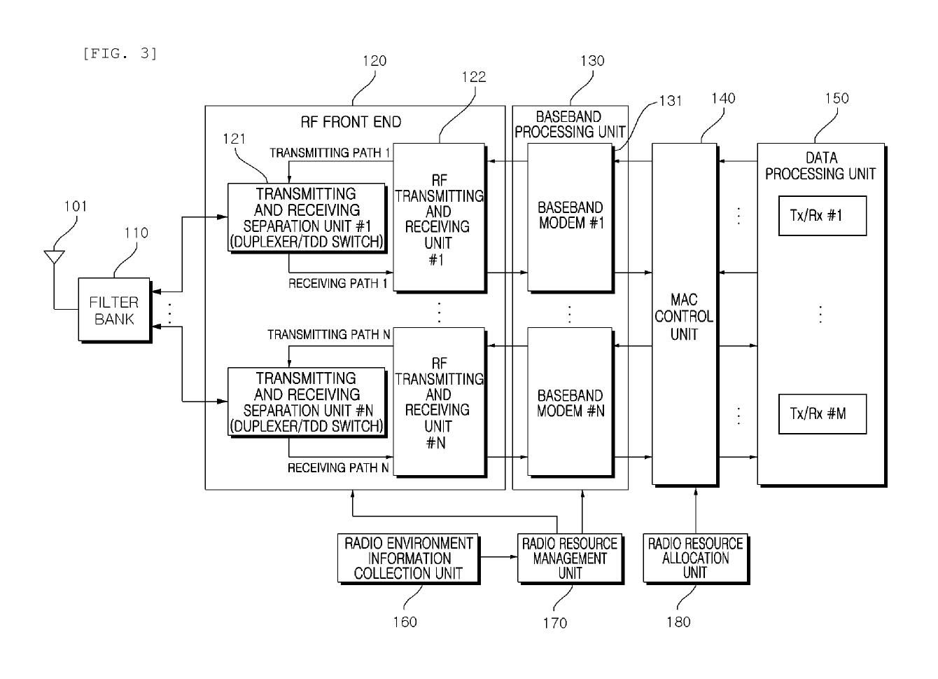

FIG. 3 is a block diagram of a duplex apparatus in accordance with an exemplary embodiment of the present invention. A duplex apparatus according to the exemplary embodiment of the present invention may be included in a cognitive radio base station in the cognitive radio communication system. However, it can be understood to those skilled in the art that functions or components of at least a part of the duplex apparatus may be included in, for example, a user equipment (UE), customer premises equipments (CPE), and the like, in addition to a cognitive radio base station.

Referring to FIG. 3, the duplex apparatus according to the exemplary embodiment of the present invention may include a wideband transmitting and receiving antenna 101, a filter bank 110, an RF front end 120, a baseband processing unit 130, an MAC control unit 140, a data processing unit 150, a radio environment information collection unit 160, a radio resource management unit 170, and a radio resource allocation unit 180. The RF front end 120 includes a plurality of transmitting and receiving separation units 121 and RF transmitting and receiving units 122 and the baseband processing unit 130 includes a plurality of baseband modems 131.

The filter bank 110 filters a signal received through the wideband transmitting and receiving antenna 101 or a signal to be transmitted through the wideband transmitting and receiving antenna 101 into a plurality of bands.

The RF front end 120 and the baseband processing unit 130 have a plurality (N in the present exemplary embodiment) of transmitting and receiving paths and include transmitting and receiving separation units 121, RF transmitting and receiving units 122, and baseband modems 131 for each transmitting and receiving path. The plurality of transmitting and receiving paths are allocated with usable radio resources that are cognized through the radio environment information collection unit 160 to be described below. The RF front end 120 and the baseband processing unit 130 allocate the transmitting and receiving paths each corresponding to a signal received from the transmitting and receiving antenna 101 and a signal to be transmitted to the transmitting and receiving antenna 101 in response to a control of the radio resource management unit 170 to be described below.

The transmitting and receiving separation unit 121 serves to separate the signal received from the transmitting and receiving antenna 101 and the signal to be transmitted to the transmitting and receiving antenna 101 and in detail, is implemented as a duplexer for an FDD mode and a TDD switch for a TDD mode. The transmitting and receiving separation unit 121 may be operated in the FDD mode and the TDD mode. That is, the transmitting and receiving separation unit 121 uses the duplexer in the FDD mode to separate the received signal and the transmitted signal and uses the TDD switch in the TDD mode to separate the transmitted and received signals.

The RF transmitting and receiving unit 122 converts the transmitted signal in a baseband into the RF signal and performs various signal processings such as amplification, frequency conversion, and the like, that are required during the conversion process and converts the RF received signal into the signal in a baseband and performs various signal processings such as amplification, frequency conversion, and the like, that are required during the conversion process.

The baseband processing unit 130 performs modulation/demodulation and various signal processings, such as automatic request (ARQ) processing, forward error correction (FEC) processing, and the like, on the transmitted signal and the received signal in the baseband. The baseband modem 131 of the baseband processing unit 130 performs symbol mapping, sub-carrier allocation, preamble and pilot insertion, and IFFT and guard section insertion on data to be transmitted to configure an OFDMA symbol in the case of IEEE 802.22 wireless rural area network (WRAN) system adopting, for example, an OFDMA scheme. For the received signal, the baseband modem 131 recovers data through a process opposite to the foregoing modulation.

The MAC control unit 140 performs resource allocation scheduling on transmitting/receiving data in response to a control of the radio resource allocation unit 180 to be described below. That is, when the radio resource allocation unit 180 allocates radio resources to each transmitting/receiving data, the MAC control unit 140 performs the resource allocation scheduling so that each transmitting/receiving data is transmitted or received through the transmitting and receiving paths corresponding to the radio resources allocated thereto.

The data processing unit 150 generates or processes the data to be transmitted and transmits the generated or processed data to the MAC control unit 140 and processes data received from the MAC control unit 140. The data processing unit 150 may have a plurality (M in the exemplary embodiment) of data processing modules.

The radio environment information collection unit 160 detects the usable radio resources and collects the radio environment information including the information of the detected radio resources. The usable radio resource may be specifically specified as a frequency band of an available channel or the frequency band and the time interval of the available channel. The radio environment information may include, for example, a frequency band of an available channel, a quality of an available channel, a characteristic of an available channel, information on whether the available channel corresponds to a licensed band or a shared band, and the like. The radio environment information may be acquired from a database or may be collected by spectrum sensing, a cognitive pilot channel (CPC), or a licensed band signal detection scheme, and the like.

The radio resource management unit 170 determines a duplex scheme for each usable radio resource based on the collected radio environment information. That is, the radio resource management unit 170 allocates the transmitting and receiving path to each usable radio resource depending on the corresponding radio environment information and determines whether the radio resource is operated in the FDD mode or the TDD mode. The transmitting and receiving separation unit 121 of the transmitting and receiving path corresponding to the radio resource determined to be the FDD mode is operated as the duplexer and the transmitting and receiving separation unit 121 of the transmitting and receiving path corresponding to the radio resource determined to be the TDD mode is operated as the TDD switch.

The radio resource management unit 170 may determine the duplex scheme for the radio resource depending on whether the usable radio resource belongs to the licensed band or the shared band and corresponds to the paired spectrum or the unpaired spectrum. The example is as follows. When the radio resource corresponds to the paired spectrum as the licensed band, the duplex scheme for the radio resource is determined to be the FDD. In the general case, the shared band is configured as several unpaired spectra, and therefore the case corresponding to the paired spectrum as the shared band may not be particularly considered. When the radio resource corresponds to the unpaired spectrum as the licensed band, the duplex scheme for the radio resource is determined to be the TDD. When the radio resource corresponds to the unpaired spectrum as the shared band, the duplex scheme for the radio resource is determined to be the TDD.

The radio resource management unit 170 may determine a grade of each radio resource or priority in consideration of characteristics or positions, service characteristics, and the like, of a system/network in which the duplex apparatus exists. In this case, the grade or the priority of the radio resource may be differently defined depending on the transmitted and received information.

In the exemplary embodiment of the present invention, a part of the usable radio resources is operated in the FDD and a part thereof is operated in the TDD, such that the system may be operated in the HDD scheme that supports the FDD and the TDD simultaneously. Therefore, the radio resource management unit 170 may determine a combination of radio resources for the HDD mode in consideration of the characteristics or positions or the service characteristics of the system/network. In this case, the combination of the radio resources may be determined in consideration of the frequency band and the licensed/unlicensed characteristics, the service characteristics, and the like, of the available channel. For example, when the solution of the inter-cell interference problem in the licensed band is required, the HDD combination may be configured using the channels in the licensed band. As another example, when the extension of cell coverage is required or the importance of information is not large but the traffic amount is large, the HDD combination including the TDD using a channel in a TV band may be configured.

The radio resource allocation unit 180 allocates at least one of the radio resources detected by the radio environment information collection unit 160 to the information to be transmitted and received, depending on the characteristics of information and in consideration of the radio environment information of each radio resource. The characteristics of information include, for example, the importance, type, service characteristics, and the like, of the corresponding information. For example, depending on the importance of the corresponding information, when the importance is relatively high, the radio resource belonging to the licensed band is allocated and when the importance is relatively low, the radio resource belonging to the unlicensed band is allocated. The radio resource allocation unit 180 may optionally allocate the radio resource determined to be the FDD and the radio resource determined to be the TDD, depending on a required quality of service (QoS), delay sensitivity, and whether channel reciprocity can be used. For example, when the required QoS is relatively high, the radio resource determined to be the FDD may be preferentially allocated, when the delay sensitivity is relatively low, the radio resource determined to be the TDD may be preferentially allocated, and when the channel reciprocity can be used, the radio resource determined to be the TDD may be preferentially allocated.

A channel needs to be stably secured in order to transmit broadcasting information, control information, and resource allocation information of the system/network to a user terminal. Therefore, according to the exemplary embodiment of the present invention, the radio resource allocation unit 180 preferentially allocates the radio resource belonging to the licensed band, in which the channel can be stably secured, to the broadcasting information, the control information, and the resource allocation information of the system/network. However, when there is no radio resource belonging to the licensed band, it is preferable to transmit the radio resource through the available channel having the high channel quality in the shared band.

For example, when there is the radio resource determined to be the FDD as the licensed band, the radio resource allocation unit 180 allocates the corresponding radio resource to the broadcasting information, the control information, and the resource allocation information of the system/network. Meanwhile, when there is the radio resource determined to be the TDD as the shared band, there is a need to transmit uplink/downlink temporal duration (UL/DL temporal duration) information for the TDD to the user terminal. The radio resource allocation unit 180 allocates the radio resource determined to be the FDD as the licensed band to the uplink/downlink temporal duration information. Therefore, the uplink/downlink temporal duration information is transmitted through the downlink of the radio resource determined to be the FDD.

As another example, when there is no radio resource determined to be the FDD as the licensed band and there is the radio resource determined to be the TDD as the licensed band, the radio resource allocation unit 180 allocates the corresponding radio resource to the broadcasting information, the control information, and the resource allocation information of the system/network. The foregoing uplink/downlink temporal duration information is also allocated to the radio resource determined to be the TDD as the licensed band. Therefore, the uplink/downlink temporal duration information is transmitted through the downlink of the radio resource determined to be the TDD.

As another example, when there is no radio resource belonging to the licensed band, the radio resource allocation unit 180 allocates the radio resource having the highest stability among the radio resources belonging to the shared band to the broadcasting information, the control information, and the resource allocation information of the system/network. The radio resource having the highest stability may be a channel having the highest channel quality. The foregoing uplink/downlink temporal duration information is also allocated to the radio resource having the highest stability. Therefore, the uplink/downlink temporal duration information is transmitted through the downlink of the radio resource having the highest stability in shared band.

In the exemplary embodiment of the present invention, the grade or the priority of each radio resource is determined in consideration of the information to be transmitted and received, the characteristics or positions, or the service characteristics, and the like, of the system/network, and the radio resource allocation unit 180 may allocate the radio resource to the information to be transmitted and received in consideration of the grade or the priority. That is, the radio resource having the high priority is preferentially allocated and when the corresponding radio resource is not present or is not used, the radio resource having the next priority is allocated.

When the information to be transmitted and received is the broadcasting information, the control information, and the resource allocation information of the system/network, the priority is firstly a downlink of the radio resource determined to be the FDD and secondly a downlink of the channel having the highest stability among the radio resources determined to be the TDD.

In the case of the service (for example, VoIP service, and the like) whose service traffic ratio of the uplink and the downlink is symmetric and QoS needs to be secured in terms of the delay, the priority is firstly the radio resource determined to be the FDD and secondly the radio resource determined to be the TDD.

In the case of the service (for example, high speed data download service) that is not greatly sensitive to the delay, the priority is firstly the radio resource determined to be the TDD and secondly the radio resource determined to be the FDD.

In the case of a multi input multi output (MIMO) transmission mode or a beamforming transmission mode that is not greatly sensitive to the delay, the priority is firstly the radio resource determined to be the TDD and secondly the radio resource determined to be the FDD. When the TDD is used, the channel frequency bands of the uplink and the downlink are the same, such that the feedback of the channel information required for the MIMO transmission may be remarkably reduced using the channel reciprocity as compared with the FDD.

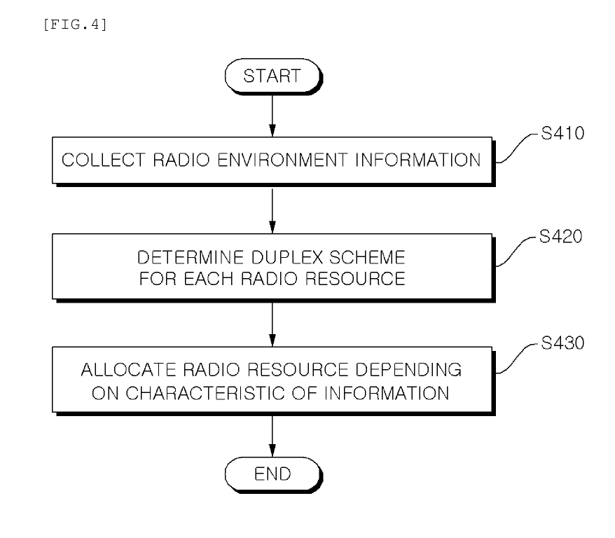

FIG. 4 is a flow chart of a method for duplex in a cognitive radio communication system according to the exemplary embodiment of the present invention.

In S410, the present method detects the usable radio resources and collects the radio environment information including the information of the detected radio resources. S410 is substantially the same as the operation of the radio environment information collection unit 160 described above, and therefore the detailed description thereof will be omitted.

In S420, the present method determines the duplex scheme for each usable radio resource based on the collected radio environment information. S420 is substantially the same as the operation of the radio resource management unit 170 described above, and therefore the detailed description thereof will be omitted.

In S430, the present method allocates at least one of the radio resources detected in the S410 to the information to be transmitted and received, depending on the characteristics of information and in consideration of the radio environment information of each radio resource. S430 is substantially the same as the operation of the radio resource allocation unit 180 described above, and therefore the detailed description thereof will be omitted.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for duplex in a cognitive radio communication system, comprising:
collecting radio environment information including information of usable radio resources;
determining a duplex scheme for each radio resource based on the radio environment information; and
allocating at least one of the radio resources to information to be transmitted and received, depending on characteristics of the information.

2. The method of claim 1, wherein in the determining, the duplex scheme for the radio resource is determined depending on whether the radio resource belongs to a licensed band or a shared band.

3. The method of claim 1, wherein in the determining, the duplex scheme for the radio resource is determined depending on whether the radio resource corresponds to a paired spectrum or an unpaired spectrum.

4. The method of claim 1, wherein in the determining, when the radio resource corresponds to a paired spectrum as a licensed band, the duplex scheme for the radio resource is determined to be FDD.

5. The method of claim 1, wherein in the determining, when the radio resource corresponds to an unpaired spectrum as a licensed band or an unpaired spectrum as a shared band, the duplex scheme for the radio resource is determined to be TDD.

6. The method of claim 1, wherein in the allocating, at least one of the radio resources is allocated depending on importance, type, or service characteristics of the information.

7. The method of claim 6, wherein in the allocating, a radio resource for which the duplex scheme is determined to be FDD and a radio resource for which the duplex scheme is determined to be TDD are optionally allocated depending on whether a required quality of service (QoS), delay sensitivity, or channel reciprocity is used.

8. The method of claim 6, wherein in the allocating, a radio resource for which the duplex scheme is determined to be FDD and a radio resource for which the duplex scheme is determined to be TDD are optionally allocated depending on symmetry of a service traffic ratio of an uplink and a downlink.

9. The method of claim 6, wherein in the allocating, when the information is broadcasting information, control information, or resource allocation information of a system/network to be transmitted to a user terminal, the radio resource belonging to a licensed band is preferentially allocated.

10. An apparatus for duplex in a cognitive radio communication system, comprising:
a radio environment information collection unit that collects radio environment information including information of usable radio resources;
a radio resource management unit that determines a duplex scheme for each radio resource based on the radio environment information; and
a radio resource allocation unit that allocates at least one of the radio resources to information to be transmitted and received, depending on characteristics of the information.

11. The apparatus of claim 10, wherein the radio resource management unit determines the duplex scheme for the radio resource depending on whether the radio resource belongs to a licensed band or a shared band.

12. The apparatus of claim 10, wherein the radio resource management unit determines the duplex scheme for the radio resource depending on whether the radio resource corresponds to a paired spectrum or an unpaired spectrum.

13. The apparatus of claim 10, wherein the radio resource management unit determines the duplex scheme for the radio resource as FDD when the radio resource corresponds to a paired spectrum as a licensed band.

14. The apparatus of claim 10, wherein the radio resource management unit determines the duplex scheme for the radio resource as TDD when the radio resource corresponds to an unpaired spectrum as a licensed band or an unpaired spectrum as a shared band.

15. The apparatus of claim 10, wherein the radio resource allocation unit allocates at least one of the radio resources depending on importance, type, or service characteristics of the information.

16. The apparatus of claim 15, wherein the radio resource allocation unit optionally allocates a radio resource for which the duplex scheme is determined to be FDD and a radio resource for which the duplex scheme is determined to be TDD, depending on whether a required quality of service (QoS), delay sensitivity, or channel reciprocity is used.

17. The apparatus of claim 15, wherein the radio resource allocation unit optionally allocates a radio resource for which the duplex scheme is determined to be FDD and a radio resource for which the duplex scheme is determined to be TDD, depending on symmetry of a service traffic ratio of an uplink and a downlink.

18. The apparatus of claim 15, wherein the radio resource allocation unit preferentially allocates the radio resource belonging to a licensed band when the information is broadcasting information, control information, or resource allocation information of a system/network to be transmitted to a user terminal.
